(19) United States
(12) Patent Application Publication
(10) Pub. No.: US 2010/0318454 A1
(43) Pub. Date: Dec. 16, 2010

(54) Function and Constraint Based Service Agreements

(75) Inventors: Heather E. Warncke, Seattle, WA (US); Eric Bahna, Seattle, WA (US); John D. Dunagan, Bellevue, WA (US); Stuart H. Schaefer, Sammamish, WA (US); Dennis B. Gannon, Bellevue, WA (US); Burton J. Smith, Seattle, WA (US); David Gauthier, Seattle, WA (US); Ferg Zhao, Issaquah, WA (US); Patrick J. Helland, Seattle, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/485,844

(22) Filed: Jun. 16, 2009

(51) Int. Cl. G06Q 30/00

(52) U.S. Cl. 705/37; 705/1.1

(57) ABSTRACT

An exemplary matching module includes instructions for receipt of information about sellable resources for running web-based services; for a solver for minimizing or maximizing a function subject to constraints; and for output of cost information for purchasing or buying sellable resources for running web-based services where the cost information is based at least in part on minimizing or maximizing the function. An exemplary matching module may be configured to receive information in a domain-specific language. Other methods, devices and systems are also disclosed.

### BACKGROUND

Large scale data centers and the Internet provide a global infrastructure for a wide variety of web-based services. Managers of such services aim to ensure excellent quality at reasonable costs. To achieve these goals, a manager of a web-based service typically enters negotiations with one or more data center operators. For example, to ensure excellent quality, a web-service may require a certain amount of memory, CPU and bandwidth and/or a certain level of reliability or availability of those resources. A data center operator may base the purchase price of such resources on a long-term model that accounts for sunk costs, power costs, expected demand for resources, etc. Such negotiations may take considerable time and have lengthy terms. In turn, the lengthy terms bind the resources and make overall operation of the global infrastructure inflexible, fraught with risk and market inefficiencies.

As described herein, various exemplary technologies allow for optimal provisioning of global computing resources. Such technologies can also drive out market inefficiencies and account for associated traffic and events that impact availability and cost of computing resources.

### SUMMARY

An exemplary matching module includes instructions for receipt of information about sellable resources for running web-based services; for a solver for minimizing or maximizing a function subject to constraints; and for output of cost information for purchasing or buying sellable resources for running web-based services where the cost information is based at least in part on minimizing or maximizing the function. An exemplary matching module may be configured to receive information in a domain-specific language. Other methods, devices and systems are also disclosed.

### DESCRIPTION OF DRAWINGS

Non-limiting and non-exhaustive examples are described with reference to the following figures:

FIG. 1 is a diagram of an exemplary system that includes an agreement mechanism to aid provisioning of global resources;

FIG. 2 is a diagram of an exemplary system that streams information and that also includes an information reservoir;

FIG. 3 is a diagram of an exemplary system that includes a matching module for simulating service costs and/or matching buyers to resources and a service agreement binder for generating binding service agreements;

FIG. 4 is a diagram of an exemplary matching scheme that includes a matching module suitable for performing, at least in part, a method for outputting cost/price for resources;

FIG. 5 is a diagram of an exemplary scheme that includes various convex programming techniques;

FIG. 6 is a diagram of an exemplary scheme for expressing information according to a domain-specific language;

FIG. 7 is a diagram of an exemplary graphical user interface (GUI) for use by an operator of an agreement mechanism;

FIG. 8 is a diagram of an exemplary graphical user interface (GUI) for use by a buyer or a seller of resources; and

FIG. 9 is a block diagram of an exemplary computing device.

### DETAILED DESCRIPTION

Various exemplary methods, devices and systems described herein pertain to provisioning resources based on information received from a buyer of resources or based on information received from a seller of resources. An exemplary agreement mechanism can receive streaming data that can assist an operator in resource provisioning. As explained in more detail below, an exemplary agreement mechanism can receive information from a buyer or a seller and output cost information for sale of resources to the buyer or output price information for purchase of resources to the seller of resources.

Various techniques for determining cost information or price information, referred to herein generally as cost information, include convex programming. Such convex programming relies on a function and associated constraints, which are developed based on various information available to an agreement mechanism. In various examples, a convex function and an associated convex set of constraints are based at least in part on information received from a buyer or a seller of resources. Additionally, a convex function and an associated convex set of constraints are based in part on information received via a data stream. Such a data stream can carry any of a variety of metrics associated with resource provisioning. For example, a data stream can include a value metric (i.e., value information) for a particular resource that can be used to make decisions about that resource.

While various examples refer to cost or price information, metrics other than cost may be used, additionally or alternatively (e.g., a monetized unit of capacity, a unit based on type of capacity such as guaranteed bandwidth or best case delivery, etc.). In the context of computing resources, an exemplary data stream can carry information as to past, present and/or future availability and/or values of computing resources. For example, past availability or values may be used to benchmark, present availability or values for near real-time resource provisioning and future availability or values for resource provisioning to meet future resource needs.

As explained, at present, purchases of global computing resources typically occur via infrequent negotiations between a data center operator and a manager of a web-based service or application. Various exemplary techniques described herein can allow for more abstract expression of needs and thereby allow a data center manager more freedom in meeting expressed needs, and for matching sellable resources, potentially including resources from multiple organizations, to buyers of resources. Such techniques can make the market for computing resources more efficient, which can benefit all players (e.g., users, web-based service/app managers, data center operators, etc.).

As described herein, various exemplary techniques allow a buyer of resources for running a web-based service to state its needs with some degree of abstraction away from the specificity common in many hosting negotiations. Such a level of abstraction can help ensure that needs of the buyer are met to run the web-based service without requiring the buyer to make certain decisions (e.g., “run at data center X on server blades Y and Z”, which may then be set aside for that buyer). When a buyer can specify its needs abstractly, a resource manager can be freed from certain constraints that can allow the manager to make decisions for efficiency and profit. While the hosting of web-based services (or applications) may still be viewed as a hierarchical decision, as explained herein, various exemplary techniques allow for agreements between parties to be made without overtly specifying resources, which, in turn, can allow resource managers to more effectively manage resources.

As described herein, an exemplary agreement module can assess resource availability and cost in near-real-time. For example, an agreement module may be configured to assess compute resource availability, ranging from details of self-reporting at the individual-resource level to building a system that spans multiple data centers (DCs) to “see” what resources are available in what location(s). In various examples, such a module relies on a data stream of information about resources (e.g., cloud resources).

As described herein, an exemplary agreement module can assess market pricing (e.g., for spot, futures or options markets, including pricing of penalties for failing to fulfill a contract). In various examples, an agreement module relies on a function and associated constraints. Such a system of equations may be viewed as expressing business rules that can account for real-time demand or other factors. The system of equations may be “solved” (e.g., maximized or minimized) to arrive at a cost for resources. For an operator of an agreement module, the specific costs may be broken down to fine levels or quanta of granularity (e.g., each compute resource). Further, for an operator of an agreement module, the cost for resources may be optimized with an overarching view (e.g., subject to constraints) to drive buyers to choose the “cheapest” instance of a specific resource that still allows an application or web-based service to meet its end user SLA or other goals.

As information flows through an agreement module, opportunities exist for reporting, monitoring and auditing. In various examples, an operator may be able to monitor terms of a service agreement with respect to resources, create historical reports and make manual changes/updates that can re-provision resources according to various business rules, which may be optionally expressed via a function and associated constraints.

As described herein, an exemplary agreement mechanism can provide for provisioning, assigning and releasing resources into or out of the marketplace. Such an agreement mechanism may also provide for billing or other administrative tasks. In various examples, an agreement mechanism informs a provisioning mechanism as to assign resources to an application or web-based service after an agreement is formed to meet needs or requirements of a buyer. Such an agreement mechanism may provide information as to specific resources (including location and quantity needed) and to determine when needs or requirements of an application or web-based service have decreased/ended. In turn, a resource manager can more readily understand when resources are released from use and suitable for re-advertisement to the agreement mechanism (e.g., via a data stream) as part of an available pool of resources, which may also potentially impact real-time price of various resources (e.g., according to supply-demand theory). A mechanism may also be configured to track resource utilization and bill buyers for actual resources consumed.

As described herein, an exemplary system can assist in implementation of a large-scale virtualized environment, particularly one that can optimize for cost by incenting buyers to consume the “most-available” (and generally cheaper) resources at all times while also allowing operators to affect the market to incent any other desired behaviors (e.g. “draining” a certain data center for maintenance). For example, an exemplary agreement mechanism, simulator or matching module can account for resource management strategies. If a data center has an oversupply of a resource, the agreement mechanism, simulator or matching module can receive information from buyers and return low pricing for the oversupplied resources. Such a scheme may rely on one or more constraints (e.g., as to location, type of resource, etc.) that may be presented to the buyers. Alternatively, where buyers specify information that is free of such one or more constrains, the low pricing may be directed specifically to these buyers.

The foregoing scheme demonstrates that various strategies become possible when aspects of abstraction and fungibility are introduced to a system. Specifically, for the buyers that are unconcerned with the location of the oversupplied resources, these resources are fungible. In other terms, a buyer may simply specify “location of resources is not important”. However, for the buyers that do indicate location as being an important factor, other aspects of a request may be analyzed to determine how resources suited to meet the request are “fungible”. As explained in more detail below, an exemplary domain-specific language can help elucidate such “fungibility” by providing levels of abstraction. Such an approach allows a buyer to more precisely state important needs without stating, for example, hardware specific or location specific requirements. Should a buyer desire to state such specific requirements, an exemplary approach that relies on a function and constraints may find an optimal solution that considers how the buyer's request is “fungible” in other ways. In essence, an exemplary approach aims to uncover the fungible aspects of a buyer's stated needs or requirements to run an application or web-based service and, in turn, provide pricing that is advantageous to the buyer and a resource manager.

Various exemplary techniques described herein may be viewed in the realm of so-called “dynamic pricing” or “price customization” where a dynamic adjustment of prices occurs for resources in a manner dependent upon value buyers attribute to the resources. However, in various schemes, the value managers of resources have for resources (current or future value) is also considered. Hence, value assigned by a manager of resources (e.g., to comply with one or more service agreements) is also a factor determinant of dynamic pricing.

Dynamic pricing typically includes aspects of price dispersion and price discrimination. Price dispersion can be spatial or temporal where for spatial price dispersion several sellers offer a given item at different prices. In temporal price dispersion, a given seller varies its price for a given good over time, based on the time of sale and supply-demand situation. Various exemplary schemes described herein include aspects of temporal price dispersion. Further, various exemplary schemes can include aspects of differential pricing or price discrimination, where different prices are charged to different buyers for the same resource.

In perfect differentiation, a seller sells different units for different prices and these prices can differ from buyer to buyer and, ultimately, each unit is sold to the buyer who values it most highly, at the maximum price that the buyer is willing to pay. In so-called nonlinear pricing, a seller sells different units for different prices but every buyer who buys the same amount of the resource pays the same amount. Thus prices depend on the amount of the resource purchased, but not on who does the purchasing (e.g., consider public utilities where the price per unit of electricity often depends on how much is bought). So-called third degree price differentiation occurs when the seller sells products to different buyers for different prices, but every unit sold to a given buyer sells for the same price.

For implementation of price customization, some of the following conditions may be considered: (i) buyers are heterogeneous in their willingness to pay; (ii) the market is segmentable; (iii) arbitrage should be limited; (iv) the cost of segmenting and price differentiation does not exceed revenue due to price customization (e.g., Priceline.com has helped the airline industry by generating additional revenues on seats that would have otherwise gone unsold); and (v) buyers should perceive fairness while dealing with a seller that practices dynamic pricing.

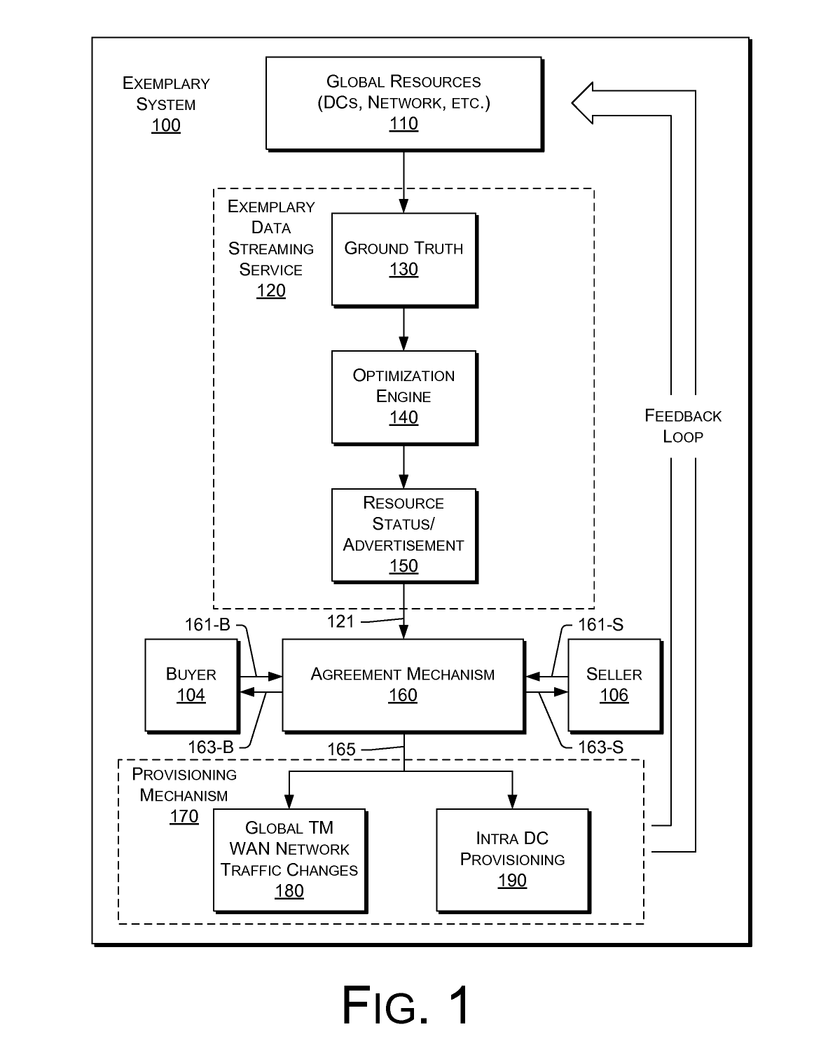

FIG. 1 shows an exemplary system 100 that includes global resources 110 (e.g., resource in “the cloud”, various data centers, etc.), an exemplary data streaming service 120 that outputs data 121, an agreement mechanism 160 to consume the data 121 and a provisioning mechanism 170 to provision at least some of the global resources 110 in response to requests to buy or sell resources per agreements formed by the agreement mechanism 160.

As described herein, a web-based service or web application manager or a buyer of resources 104 can interact with the agreement mechanism 160 to enter into an agreement as to resources, for example, to run a web-based service. As shown in FIG. 1, the agreement mechanism 160 may be optionally configured to interact with a seller of resources 106. For example, a data center manager may sell resources in a data center that are not currently fully utilized or, according to a schedule or demand analysis, are not expected to be fully utilized at some time or period(s) of time in the future.

As explained in more detail below, the buyer 104 can specify requirements 161-B and the agreement mechanism 160 can, in turn, form a function and associated constraints based at least in part on the specified requirements. A similar approach may be used for a seller that specifies the nature of its sellable resources 161-S, which can be used, at least in part, to form a function and associated constraints.

For the buyer 104, the agreement mechanism 160 can perform an optimization (e.g., minimization or maximization) of the function subject to the associated constraints and return to the buyer 104 a cost for resources 163-B that meet the specified requirements or a variation thereof. Accordingly, a service agreement may be entered into between the buyer 104 and a resource manager via the agreement mechanism 160. Similarly, the agreement mechanism 160 may return to the seller 106 a cost for the seller's resources 163-S, for example, based on information (e.g., data 121) about current or future state of the global resources 110 provided by the data streaming service 120.

As shown in FIG. 1, the resource provisioning mechanism 170 creates a feedback loop such that changes that occur through resource provisioning per agreements made via the agreement mechanism 160 are continuously accounted for by the exemplary data streaming service 120. In such a manner, the data streaming service 120 can provide timely information (e.g., dynamic information) as to cost and availability of at least some of the global resources 110. The data stream 121 output by the service 120 may optionally be an advertisement stream that advertises various aspects of resources such as time availability, quantity, cost, etc. Alternatively, the data stream 121 output by the service 120 may be a stream for consumption by one or more agreement mechanisms (e.g., such as the agreement mechanism 160) with no or limited exposure to buyers or sellers of resources. For example, in various examples described below, a simulator or matching module allows buyers or sellers to provide requirements and receive output indicating cost or cost estimates based at least in part on the provided requirements.

The exemplary data streaming service 120 includes modules 130, 140 and 150. The module 130 is labeled “ground truth” as it acquires “raw” data about at least some of the global resources 110. For example, the module 130 may acquire information from a data center as to the number of blades, the amount of memory per blade, the availability of the memory for the next two months, the bandwidth of communications links to the data center, the cost of power to the data center, the geographical location of the data center, etc.

The module 140 is an optimization engine that transforms (or aggregates) the raw data to meaningful information using one or more algorithms. Such algorithms may be learning algorithms that can receive input related to trends in computing, measured or prospective benchmarks for equipment, trends in demand for resources (e.g., night, day, geographic, time of week, etc.), etc. In turn, the module 140 can output a variety of information relevant to current and possible future states of the resources (e.g., a time-space continuum of available resources). The module 140 can also include value information such as pricing information, for example, that assigns a price to a resource based on time, quantity, location, etc.

The module 150 receives information from the optimization engine 140 and then transforms the information to a standard form relevant to prospective purchasers, for example, the module 150 may operate according to a general schema that specifies resource type, quantity, value (e.g., price), availability, etc.

As mentioned, the agreement mechanism 160 consumes the data 121 output by the service 120. This agreement mechanism 160 allows computing devices (e.g., automatically or by manual operation by managers or buyers or sellers of resources) to readily make requests or place bids for acquisition or sale of resources (e.g., 161-B, 161-S). Upon agreement by the agreement mechanism 160, agreed to requests 165 (e.g., per one or more service agreements) are sent to the provisioning mechanism 170, which includes a Traffic Management (TM) component 180 and an intra data center provisioning component 190.

The TM component 180 accounts for network traffic as a data center may have resources but insufficient bandwidth to allow those resources to be used in a particular manner. Further, an adverse event (or planned event) may occur that affects the global resources. For example, an earthquake may render a data center inoperable and in turn may cause traffic management issues. In response, an exemplary service streams data that reflects such events and can optionally price resources accordingly. A TM component 180 may rely on such a data stream to manage global traffic and such information may also be used by one or more data centers for intra data center provisioning (e.g., per component 190).

As described herein, an exemplary data streaming service receives inputs, analyzes the inputs and streams information that allows others to make strategic decisions as to managing, scheduling, purchasing, etc., resources. Such a service can operate dynamically to update the streamed information responsive to particular events, a time interval, etc. For example, a release date for resources in a data center may by an input that causes an update to a resource availability metric for that date or the service may receive inputs, analyze inputs and update the stream according to a time interval (e.g., every 30 seconds). Such a service promotes efficient management of global computing resources and, in turn, promotes efficiency of the global computing system or “cloud”. The inputs can be any of a variety of inputs including, but not limited, to electrical capacity, electrical redundancy, cooling capacity, temperature thresholds, physical limitations (e.g., as to network ports), logical limitations (e.g., as to active directory authentications), etc. While inputs may be typically provided by one or more data centers, other global resources may also provide inputs. Such other resources that can provide inputs include, for example, DNS equipment, satellite equipment, fiber optic equipment, weather monitoring equipment, power generation equipment, etc. With respect to networking, inputs may pertain to network availability, bandwidth at access, core and edge layers, BGP routing, QoS, peering price, etc.

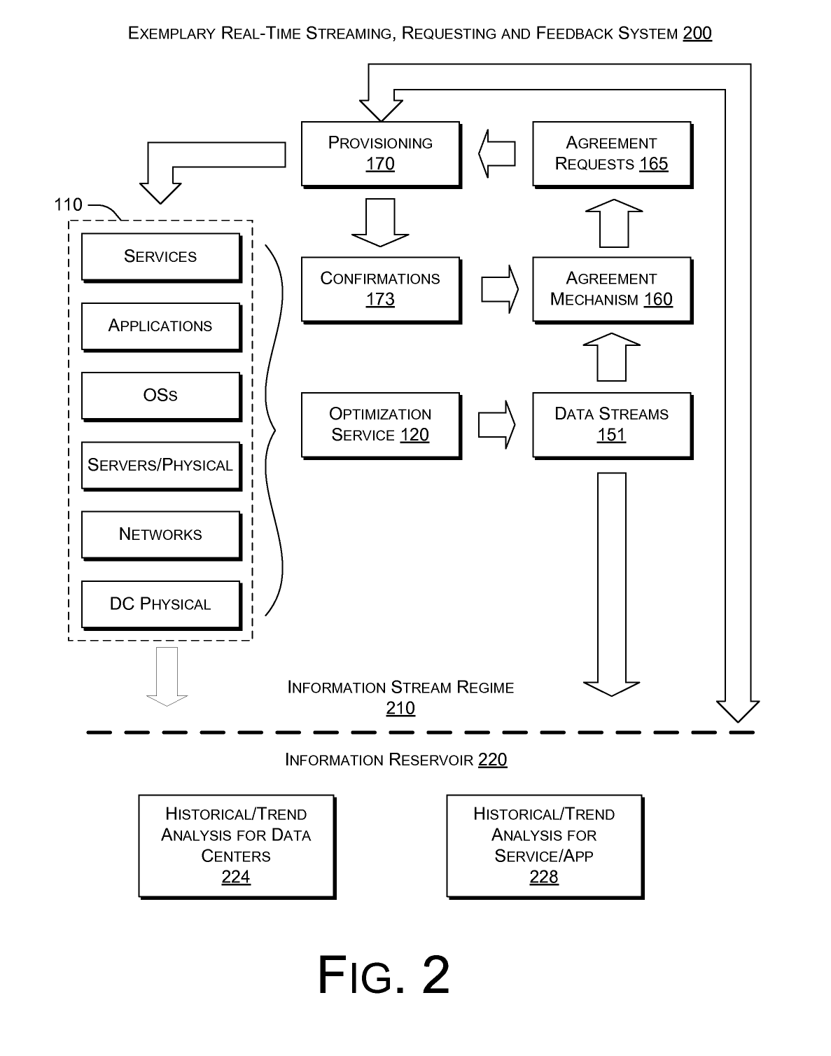

FIG. 2 shows various aspects of a real-time streaming, requesting and feedback system 200. Various features such as 110, 120, 121, 160 and 170 have already been described. A confirmation mechanism 171 may be implemented to provide some feedback to the agreement mechanism 160 as to confirmation of the agreed to requests or agreement requests 165 by the provisioning mechanism 170.

The exemplary system 200 of FIG. 2 further illustrates an information stream regime 210 and an information reservoir 220. In this example, the optimization service 120 is an active service that streams information in one or more data streams 151 much like a stock ticker that streams equity prices for one or more stock markets. Analogous to stock tickers, what was at one time “real-time” data becomes historical data, which may be stored in the information reservoir 220. The analogy to stock information is helpful in describing the system 200. For example, a person making a decision to purchase shares of a traded company may examine real-time trading data and historical data to arrive at a decision. At present, for the realm of global computing resources, the real-time data is not readily available or actionable. As described herein, an exemplary system provides real-time or near real-time data about global computing resources and provides a mechanism for forming service agreements to acquire or purchase resources. Per the system of FIG. 2, the optimization service 120, the agreement mechanism 160, the provisioning mechanism 170, etc., may also have access to the information reservoir 220.

In the example of FIG. 2, a historical/trend analysis module for data centers 224 and a historical/trend analysis module for web-based services and applications 228 may be available for analyzing information in the information reservoir 220. As indicated, the information reservoir 220 may be repository for the raw information from the global resources 110, from the service 120, from the agreement mechanism 160 and/or from the provisioning mechanism 170. Further, the information reservoir 220 may be helpful for performing audits on service agreements of the agreement mechanism 160 (e.g., to understand whether various terms of a service agreement were met or not).

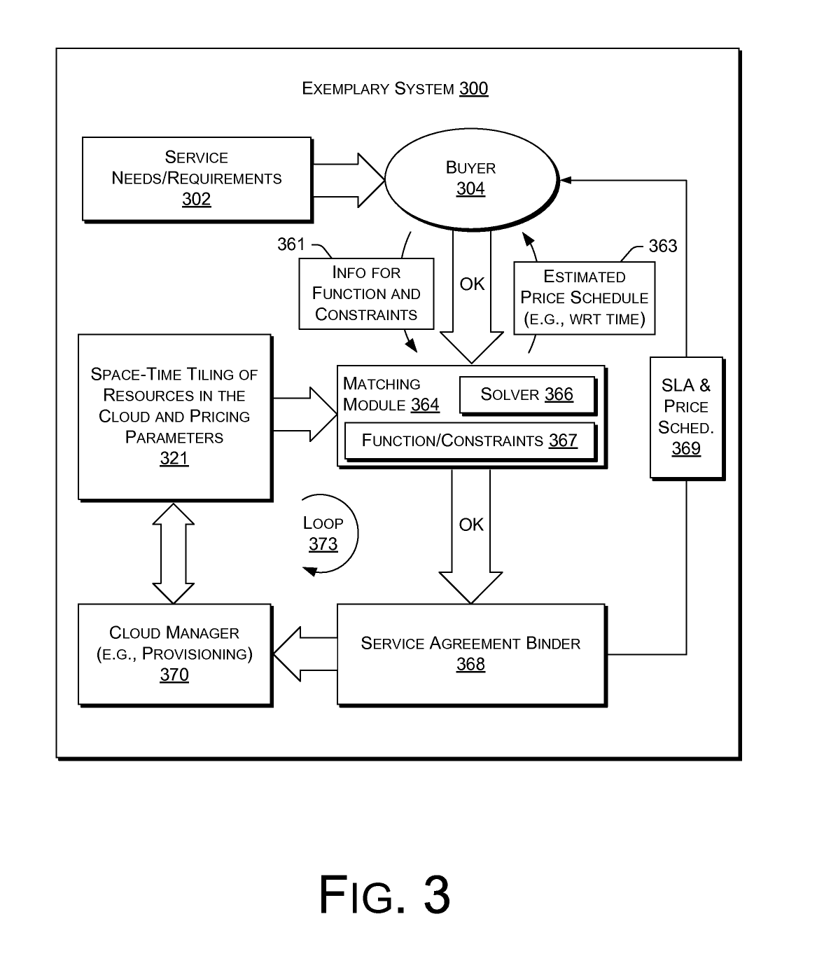

FIG. 3 shows an exemplary system 300, for example, for a buyer 304 of resources that meet needs or requirements of a service 302 (e.g., a web-based service). The system 300 includes a matching module 364 (or simulation module), a service agreement binder 368 (or binder module) and a cloud manager 370 (e.g., for provisioning resources). As described herein, the matching module 364 and the binder 368 may be components of the agreement mechanism 160 of FIGS. 1 and 2. The cloud manager 370 may be a component of a cloud services platform. For example, the AZURE® Services Platform (Microsoft Corporation, Redmond, Wash.) is an Internet-scale cloud services platform hosted through data centers of Microsoft Corporation. As described herein, an exemplary cloud services platform may include a matching module such as the matching module 364 and optionally a binder such as the binder 368.

In the example of FIG. 3, the buyer 304 (e.g., acting via a networked computing device) interacts with the matching module 364 (e.g., which may be another networked computing device). As shown, the buyer 304 communicates information 361 to the matching module 364 where the information may be a function and associated constraints or information for a function and associated constraints that are germane to the needs or requirements of the service 302. In turn, the matching module 364 relies on a solver 366 to maximize an objective, for example, by minimizing or maximizing a function and associated constraints 367. In this example, the function and associated constraints 367 may be provided by the buyer 304, be based in part on a function and associated constraints provided by the buyer 304, be based in part on constraints provided by the buyer 304, be based in part on information provided by the buyer 304, etc.

As shown in the example of FIG. 3, the matching module 364 also receives information such as a space-time tiling of resources in the cloud 321, optionally along with pricing parameters. The space-time information 321 may be provided per the data stream 121 of FIGS. 1 and 2.

Given sufficient information from one or more sources, the matching module 364 minimizes or maximizes the function and constraints 367 and outputs information 363 for the buyer 304. The outputted information 363 may be an estimated or actual price or price schedule (e.g., with respect to time) that aims to meet the needs or requirements for the service 302, as expressed by the information 361 provided by the buyer 304 (e.g., buyer as a source of information) and received by the matching module 364 and optionally based in part on the space-time information 321 (e.g., data stream about resources as a source of information).

The system 300 can allow the buyer 304 to adjust its needs or requirements for the service 302 (e.g., optionally by adjusting the service) and repeatedly submit information 361 to the matching module 364. When the buyer 304 determines that information 363 output by the matching module 364 is suitable or acceptable, the buyer 304 may enter a confirmation (e.g., “OK”). A confirmation may be optionally submitted to the matching module 364 via the information 361. For example, the buyer 304 may submit the information 361 with a parameter that indicates “simulate” or “buy”. Accordingly, the matching module 364 acts to “buy” the resources when the parameter indicates “buy”; otherwise, the matching module 364 may act simply to output information 363 without binding the buyer 304.

Upon a receipt of a “buy” order, the matching module 364 issues a confirmation to the service agreement binder 368. In the example of FIG. 3, the service agreement binder 368 generates and issues a service agreement 369 to the buyer 304 (e.g., to an address associated with the buyer, which may be a physical address or a network address such as an email or IP address). The service agreement 369 may be a service level agreement and may include a price schedule that optionally provides price for various times, levels of demand, etc. The binder 368 also acts to transmit information to a cloud manager 370 that can provision resources to meet the service agreement 369.

In the system 300, the loop formed by the matching module 364, the binder 368, the cloud manager 370 and the space-time information 321 may be within the control of one or more entities that do not include the buyer 304. Accordingly, for example, the operator of binder 368 or the cloud manager 370 may be able to optimize resource utilization and associated costs while still meeting the terms of a service agreement or even to make trade-offs between penalty terms in a service agreement and opportunities to more effectively utilize resources, decrease costs, increase profits, etc.

In the example of FIG. 3, the matching module 364 may provide information to the binder 368 to allow for dynamic agreements. In such an example, a loop 373 may be formed that feeds back information to alter terms of an agreement or to alter pricing in an agreement depending on changes in the cloud. For example, if the buyer 304 consents to a dynamic agreement, the SLA and price schedule 369 may state conditions that trigger price changes. Consider a scenario where the buyer 304 receives a discount for using data center resources that operate according to certain energy standards. The buyer 304 may submit information 361 that indicates, for example, “at least 50% of the energy consumed by data center resources must come from clean energy sources”. Such a requirement may be linked to carbon credits or other benefits for the buyer 304. For a dynamic agreement, if a qualifying data center goes off-line and, in turn, causes compute or storage to be moved to a data center that does not meet the 50% target, the price paid by the buyer 304 may be adjusted accordingly. In such a scenario, the binder 368 may communicate an update to the buyer 304 that indicates a price according to the schedule 369 or an alternative pricing, with best efforts, that aims to provide the buyer 304 with the best available alternative.

A dynamic scenario may also be driven by a hosted service. For example, if the buyer 304 enters into an agreement to host a service and the service experiences a spike in demand, the loop 373 may cause the matching module 364 to identify resources to meet the demand, cause the binder 368 to communicate information to the buyer 304 (e.g., “purchased and provisioned additionally resources according to clause X of the SLA according to the following terms . . . ”) and cause the cloud manager 370 to provision the identified resources. Given sufficient computing resources for these mechanisms, the resources may be made available in near real-time to meet the spike in demand without any unacceptable delay to the users of the service. For example, if the users of the service make requests that generate a queue, once the queue exceeds a certain length (e.g., which may corresponds to an estimated wait time), the matching module 364 may be triggered to cause the cloud manager 370 to provision more resources such that none of the users in the queue experience a wait time that might violate the SLA or part of the SLA. In such a scenario, the binder 368 may notify the buyer 304 “queue length trigger implemented, additional resources purchased and provisioned”. In this scenario, the stream 321 may include information that identifies services as associated with queues.

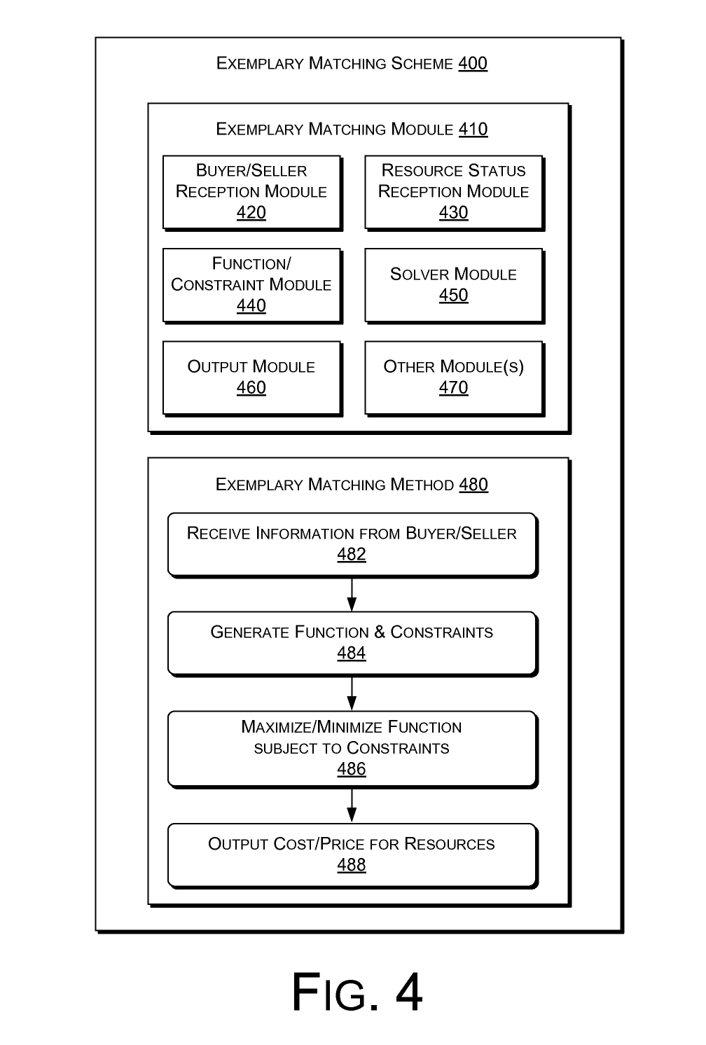

FIG. 4 shows an exemplary scheme 400 that includes a matching module 410 and a method 480 that may be implemented, at least in part, using the matching module 410. As described herein, the module 410 has a modular structure with a buyer/seller reception module 420, a resource status reception module 430, a function/constraint module 440, a solver module 450, an output module 460 and optionally one or more other modules 470.

According to the exemplary method 480, in a reception block 482, the matching module 410 receives information from a buyer or a seller. In a generation block 484, the function/constraint module 440 generates a function and one or more constraints that correspond to information received from the buyer or the seller. In a maximization or minimization block 486, the solver module 450 maximizes or minimizes the function subject to the one or more constraints that correspond to information received from the buyer or the seller. In an output block 488, the output module 460 outputs information for the buyer or the seller, for example, such as cost or price information for resources. In the example of FIG. 4, the function/constraint module 440 may optionally be an objective module and the solver module 450 may optionally be an algorithm module to maximize an objective (e.g., via minimization or maximization or other mathematical technique).

In the exemplary scheme 400, with respect to a seller, consider a seller that possesses rights in resources (e.g., ownership of resources or rights to use resources for some period of time) and may desire to sell the resources (e.g., for a price that breaks even, makes a profit or mitigates a loss). In this example, the seller may be a web-based service manager, a market maker or an arbitrageur. The matching module 410 and associated method 480 allows the seller to determine a price for the sellable resources (or leasable resources) and to optionally enter into an agreement where the seller is obliged to provide at least some of the resources to a manager (e.g., a cloud manager or data center manager) or provisioning mechanism.

As described herein, a matching module can include instructions (e.g., stored in one or more computer-readable media for execution by one or more processors) for receipt of information, from a buyer of resources, for running a web-based service; receipt of information about sellable resources for running web-based services; an algorithm for matching one or more buyers of resources to sellable resources by maximizing an objective where the matching is based at least in part on received information from one or more buyers of resources and based at least in part on received information about sellable resources; and output of cost information for sellable resources matched to one or more buyers where the cost information is based at least in part on maximizing the objective. As described herein, maximizing an objective may involve minimizing or maximizing a function. In various examples, an algorithm for matching includes a convex solver (e.g., as used in convex programming).

Similarly, for a seller, a matching module can include instructions (e.g., stored in one or more computer-readable media for execution by one or more processors) for receipt of information from a seller of resources; receipt of information about availability or demand for sellable resources for running web-based services (e.g., optionally information from one or more buyers, a data stream, etc.); an algorithm for matching one or more sellers of resources to one or more buyers (or likely buyers) of resources by maximizing an objective where the matching is based at least in part on received information from one or more sellers of resources and based at least in part on received information about availability or demand for sellable resources (e.g., optionally information from one or more buyers, a data stream, etc.); and output of price information for at least some of the sellable resources where the price information is based at least in part on maximizing the objective.

In the foregoing example, the output may state that only some of the sellable resources are of interest. For example, if the sellable resources include some discrete resources that are below a sellable base unit level (e.g., a single processor), then the output may indicate that there is no market for those discrete resources. Notably, an algorithm can optionally allow for pooling of otherwise orphaned resources to generate a set or sets of resources that may be of interest to buyers. Hence, a seller may be able to sell its sellable resources by pooling them with other resources from one or more other sellers (e.g., resources owned or managed by different organizations). Similarly, a buyer may be able to buy resources seamlessly as a set even though the resources in the set are provided by more than one organization. Such flexibility to pool resources can help bridge a buyer's needs (e.g., availability as a percentage of uptime and VMs) and a seller's needs (e.g., physical CPUs and a fixed maintenance schedule).

As described herein, a scheme may be configured that allows a buyer or a seller to specify information in a domain-specific language. In such a scheme, a matching module may include instructions for translating information specified in the domain-specific language, for example, to a function, one or more constraints or a function and one or more constraints. In another example, a domain-specific language may specify constraints that constrain a matching algorithm (e.g., for use in maximizing an objective). Particular constraints may pertain to availability of resources for running web-based services. A domain-specific language may include language to specify a set or sets of resources (e.g., as a sellable unit, as a buyable unit, etc.).

As described herein, a matching module may receive cost information about the resources in the cloud that optionally includes spot prices, future prices and/or options prices. For example, if a seller of resources wants to sell resources into the cloud at some time in the future, the matching module may formulate a function with one or more appropriate constraints around the specified future time, the nature of the resources for sale by the seller and the future price or prices of resources in the cloud. The matching module may maximize a purchase price according to the function and the one or more constraints and then output the price to the seller. In turn, if the seller accepts the price, then the matching module or other module may bind the seller to delivery of the resources at the specified price to thereby form a service agreement between the seller and another party. In this or another example, the matching module may receive availability information for resources in the cloud with respect to time (e.g., without specific price information).

As explained, a matching module can include instructions for receipt of a buy order from a buyer of resources for running a web-based service where the buy order is responsive to output of cost information to the buyer. Further, a matching module can include instructions, responsive to receipt of a buy order, to generate a service level agreement for a buyer of resources. Similarly, a matching module can include instructions for receipt of a sell order from a seller where the sell order is responsive to output of price information to the seller and instructions to generate a service agreement for the seller of resources, responsive to receipt of a sell order.

In the foregoing examples for a buyer or a seller of resources, the matching module may operate on a fee basis for providing simulations, matching or for generating and issuing binding service agreements. For example, a percentage may be charged against a sales or purchase price where the percentage increases in a manner dependent on the number of simulations performed by a prospective buyer or seller. In this example, a buyer or seller is thereby encouraged to keep the number of simulations to a minimum.

An exemplary module may include one or more mechanisms to track a particular buyer or seller and that buyer's or seller's behavior (e.g., interactions with the system, optionally including inspection of data). Such module may call for proactive measures if an interaction or interactions (or data) violate a policy. For example, a module may determine that interactions by a seller exceed a predetermined frequency, which may suggest inappropriate use of an automated system. In response, the module may issue an alert to ban the seller from further interaction. In another example, in response to certain behavior, such a module may ban a buyer or seller or otherwise impede the buyer's or seller's ability to consume simulator resources without executing an order. While simulator trend information may be used legitimately by a seller or the market, an exemplary module may ensure that a buyer or a seller cannot game prices by running many deceptive simulations.

As described herein, various exemplary schemes include a convex function and constraints, as encountered in the field of mathematics referred to as convex programming. Convex programming pertains to situations where an objective function is convex and the constraints, if any, form a convex set. Convex programming can be viewed as a particular case of nonlinear programming or as a generalization of linear or convex quadratic programming.

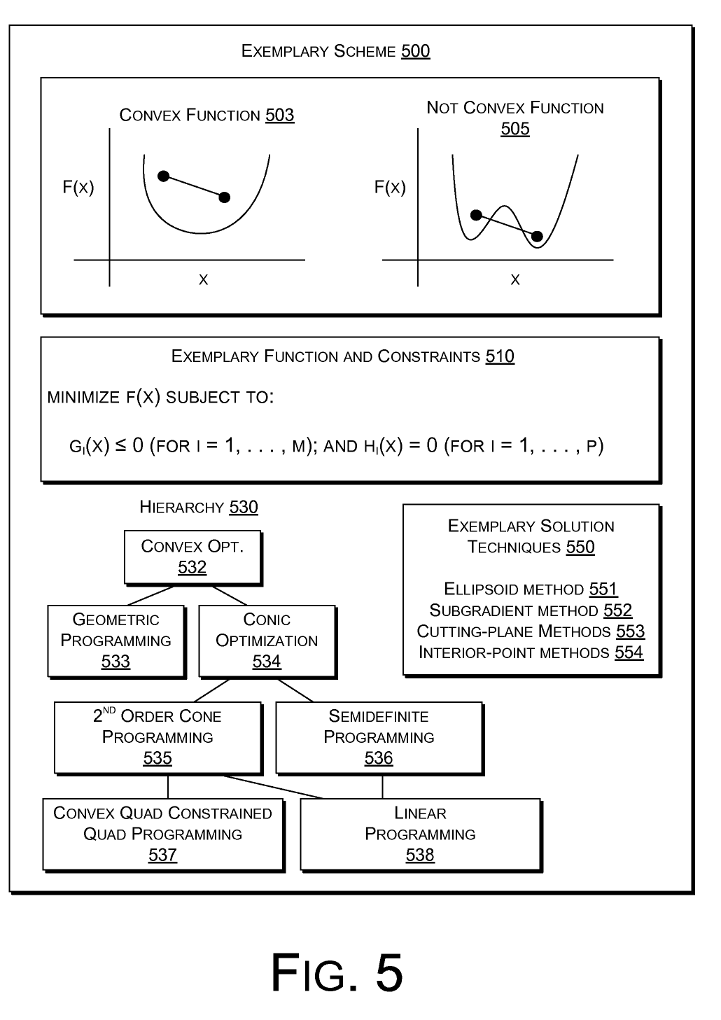

FIG. 5 shows an exemplary scheme 500 that includes a convex function and constraints that form a convex set. According to the scheme 500, a convex optimization problem may be defined where: if a local minimum exists, then it is a global minimum; the set of all (global) minima is convex; and if the function is strictly convex, then there exists at most one minimum.

The scheme 500 shows a simple example of a convex function 503 and a not convex function 505, as a line between two points crosses the function 505. As shown in FIG. 5, a standard form of describing a convex optimization problem includes three parts: (i) a convex function f(x) to be minimized over the variable x (e.g., commonly a vector); (ii) inequality constraints of the form gᵢ(x)≦0, where the functions gᵢ are convex; (iii) equality constraints of the form hᵢ(x)=0, where the functions hᵢ are affine. In practice, the terms “linear” and “affine” are often used interchangeably. The constraints can be expressed in the form h(x)=Ax+b, where A is a matrix and b is a vector. Given the foregoing notation, a convex optimization problem can be written as: minimize f(x) subject to gᵢ(x)≦0 (for i=1, . . . , m) and hᵢ(x)=0 (for i=1, . . . , p). In such a formulation, an equality constraint h(x)=0 can be equivalently replaced by a pair of inequality constraints h(x)≦0 and −h(x)≦0. Therefore, for theoretical purposes, equality constraints are redundant; however, it can be beneficial to treat equality constraints in a special manner in practice.

FIG. 5 also shows a hierarchical representation of convex optimization problems 530. The hierarchy 530 includes types of problems that are convex optimization problems or can be transformed into convex optimization problems, for example, via a change of variables. The hierarchy specifically includes convex optimization 532 at the top followed by geometric programming 533, conic optimization 534, 2^{nd} order cone programming 535, semidefinite programming 536, convex quadratic constrained programming 537 and linear programming 538. Others may include least squares and entropy maximization.

The theoretical framework for convex optimization includes notions from convex analysis such as the Hilbert projection theorem, the separating hyperplane theorem, and Farkas's lemma. As shown in FIG. 5, some exemplary solution techniques 550 suitable for solving convex optimization problems include the ellipsoid method 551, subgradient methods 552, cutting-plane methods 553 and interior-point methods 554. Again, a convex function can be defined as having no local minima that are not global, a convex set having a nonempty relative interior, and a convex set that is connected and having feasible directions at any point.

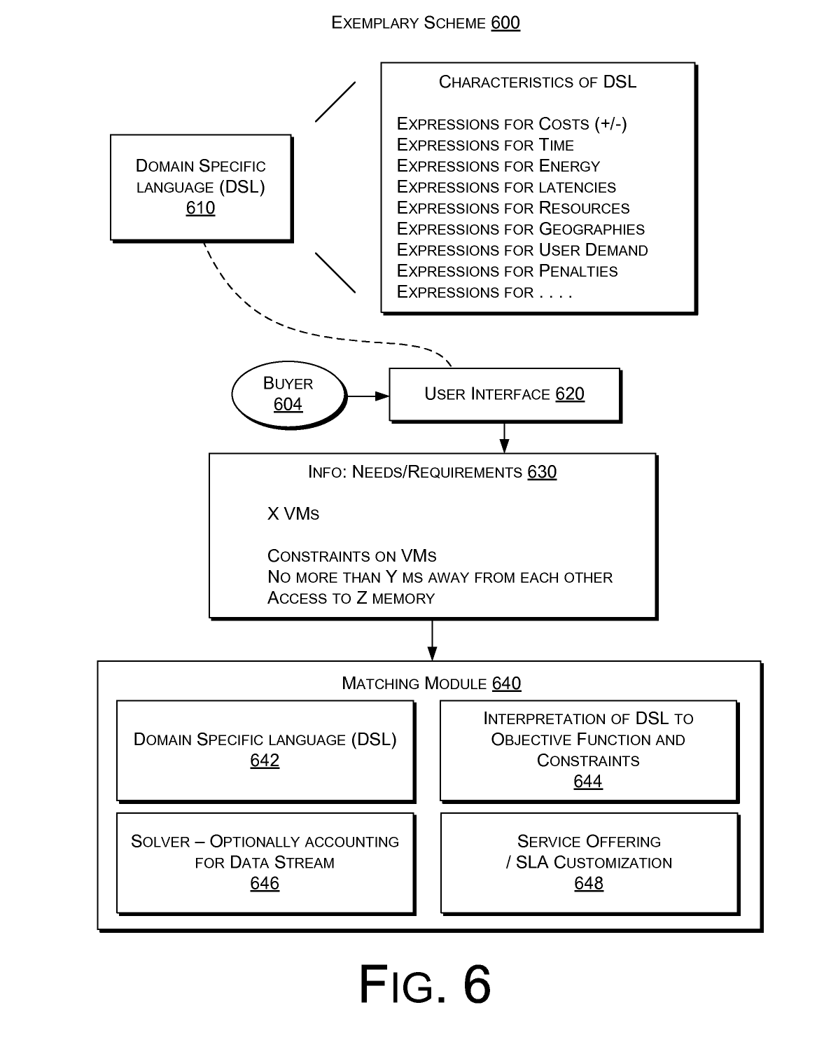

FIG. 6 shows an exemplary scheme 600 that includes an exemplary domain-specific language (DSL) 610 for expressing need or requirements or resources for sale. In the example of FIG. 6, the DSL allows for expression of costs (e.g., positive or negative), time (e.g., times, frequencies, time periods, etc.), energy (e.g., type of energy, energy consumption, etc.), latencies (memory access, runtime, compilation, queuing, network, etc.), resources (e.g., memory, CPU, bandwidth, etc.), geographies (e.g., for storage, compute, users, etc.), user demand (e.g., demand peaks, valleys, etc.), availability (e.g., fraction of uptime over given period of time), penalties (e.g., credit, etc.), and/or other factors related to resources, web-services, end users, etc.

Unlike a general-purpose language such as C#, a domain-specific language is designed to handle a particular problem space, or domain. Domains can be defined in many different ways. Some domains are associated with specific industries or kinds of business, for example, the insurance domain, the financial services domain, or the library domain. As described herein, the exemplary domain-specific language 610 relates generally to resources of the cloud or one or more data centers and factors related to such resources (e.g., energy, end users, etc.).

Domain-specific languages are generally languages, declared syntaxes or grammars with specific goals. The domain-specific language 610 may be created using so-called domain-specific language tools. The domain-specific language 610 may be a textual domain-specific language, possibly with an XML schema, or a graphical domain-specific language. The domain-specific language 610 may be extensible for expansion over time to accommodate changes in operation of the cloud, data centers, technologies, etc.

As described in the example of FIG. 6, the scheme 600 includes a user interface 620 for a buyer 604 of resources. The user interface 620 may be a web-based interface displayable on a display device configured to receive input from the buyer 604. As shown, the user interface 620 relies on the DSL 610 to allow the buyer 604 to express information as to its needs or requirements 630. For example, the user interface 620 may display graphically various resources commonly associated with hosting a web-service. The buyer 604 may select various resources such as VMs, memory, bandwidth and constrain the selected resources according to factors such as latency, geography, type, etc.

In the example of FIG. 6, the user interface 620 communicates information 630 (e.g., as needs or requirements) that call for a certain number of virtual machines (“X VMs”, where X is a positive number) with constraints as to delays between the VMs (“no more than Y ms away from each other”, where Y is a positive number), access to particular memory (“access to memory Z”, where Z is a type of memory, e.g., flash or RAM). More elaborate requests that specify sets of desired resources are also possible, for example, “X VMs in location 1 and Y VMs in location 2.”

According to the scheme 600, a matching module 640 receives the information 630 from the user interface 620. As shown, the matching module 640 includes a DSL module 642, an interpretation module 644, a solver module 646 and a service offering or SLA customization module 648. The DSL module 642 includes information and logic related to the DSL 610. The interpretation module 644 relies on the DSL module 642 to interpret the information 630 received from the user interface 620 and to thereby transform the information 630 to an objective function and one or more constraints.

In the exemplary scheme 600 of FIG. 6, the solver module 646 of the matching module 640 maximizes or minimizes the objective function subject to the one or more constraints, optionally accounting for other information, for example, as received via a data stream (e.g., the data stream 121). Specifically, the solver module 646 may adjust or alter an objective function, adjust or add one or more additional constraints, etc., for example, based on information other than that received from the user interface 620. Such adjustments, alterations or additions may account for factors known to a cloud manager or data center manager and an operator of the matching module 640, which may allow such parties to optimize operations or profits in a manner hidden from the buyer 604. While the example of FIG. 6 includes a matching module 640, a simulation module may be implemented in the scheme 600 where the simulation module may include one or more of the modules 642, 644, 646 and 648. As described herein, a matching module or a simulation module may be optionally configured to simulate buying/selling of resources (e.g., for “what if” scenarios) and to participate in buying/selling of resources. Whether for simulation or participation, matching may occur between buyer needs or requirements and sellable resources.

As described herein, an exemplary interpretation module includes instructions (e.g., stored in one or more computer-readable media for execution by one or more processors) for receipt of information in a domain-specific language (e.g., for specifying properties of resources for hosting web-based services) and for interpreting the information in the domain-specific language to generate one or more constraints for a solvable problem. In this example, the problem may be a convex problem that includes a convex objective function for minimization or maximization subject to the one or more constraints (e.g., convex constraint(s)) by a convex solver. A solution to such a minimization or maximization problem can provide for pricing resources (e.g., resources for hosting web-based services). As described herein, a solver that provides for pricing resources may include one or more prices selected from a group consisting of spot prices, future prices, option prices and penalty prices.

As described herein, an exemplary DSL may allow for expression of one or more constraints selected from a group consisting of positive cost constraints, negative cost constraints, time constraints, energy constraints, latency constraints, resource constraints, geography constraints, availability constraints, demand constraints and penalty constraints. A DSL may additionally or alternatively allow for expression of one or more constraints associated with an existing service level agreement or a prospective service level agreement.

As described herein, an exemplary DSL can include levels of abstraction for resources for hosting web-based services. For example, such levels of abstraction can include a base level (e.g., for resources such as physical memory, physical processors, physical servers and physical bandwidth). Another level of abstraction may include operational factors such as latency. In an exemplary implementation, sellable resources are expressed at a base level, while information from buyers of resources specifies desired properties at a higher level, so as to allow more flexibility in the matching of available resources to their desired use, potentially benefitting all parties.

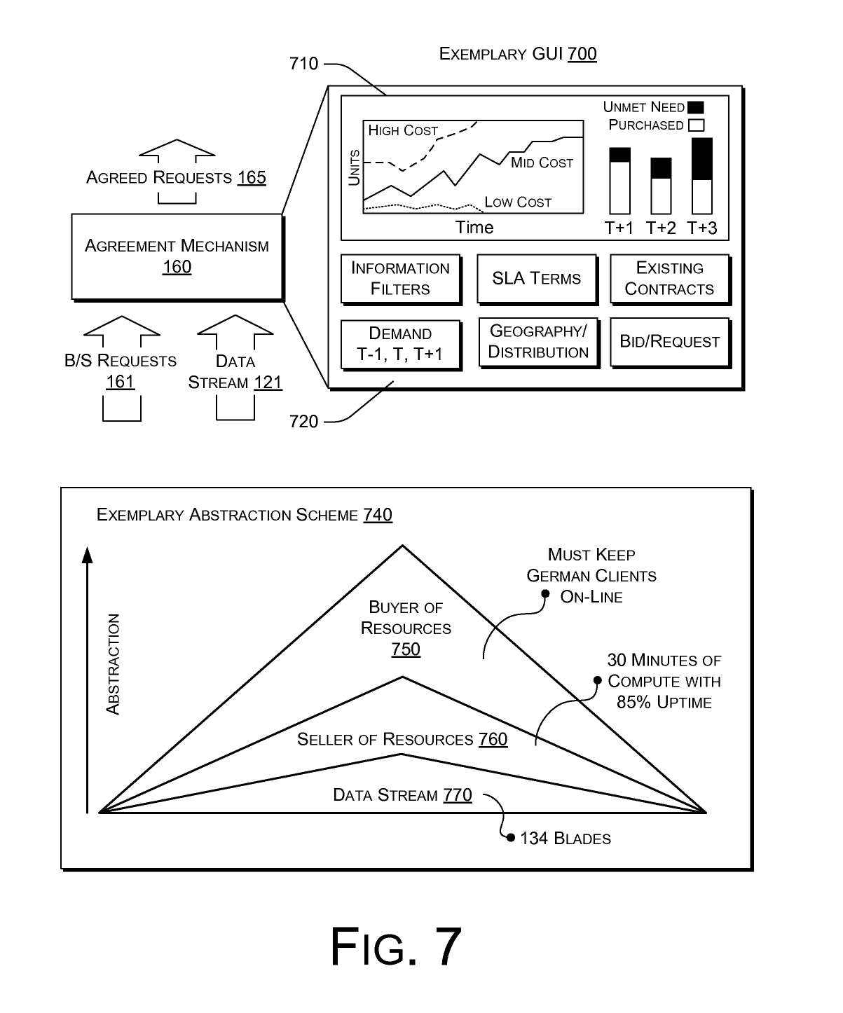

FIG. 7 shows an exemplary graphical user interface (GUI) 700 for use by an operator of an agreement mechanism 160 (e.g., via an automatically or manually operated computing device) along with an exemplary abstraction scheme 740. As mentioned, the agreement mechanism 160 can consume a data stream 121 emitted by a data streaming service 120 where the data stream includes information about global resources and receive requests from buyers or sellers of resources 161. In turn, the agreement mechanism 160 can communicate agreed requests 165 for such resources based at least in part on the information in the data stream 121 (e.g., automatically or manually) and/or the information in the buyer/seller requests 161.

As described herein, information may be in a manner dependent on the perspective or needs of a particular entity. For example, the scheme 740 aims to show how a buyer of resources 750 may specify needs more abstractly than a seller of resources 760 and a data stream 770. For example, the data stream 770 may specify availability of “134 blades” while a seller of resources 760 may specify “30 minutes of compute with 85% uptime” for sale. In contrast, a buyer of resources 750 may specify “must keep German clients on-line”. When a buyer specifies needs abstractly, a mechanism may have more freedom in matching sellable resources to the buyer's needs. In essence, many variations may exist for defining a set or sets of resources to meet the buyer's needs. The mechanism may select the best set or sets of resources to maximize an objective (e.g., profit, cost, service, etc.). In various examples, a matching module may receive information from a buyer of resources and receive information about sellable resources where the information differs in format, character, etc. For example, information from a buyer of resources may be abstracted information, abstracted at a higher level than information about sellable resources.

In the example of FIG. 7, the buyer/seller requests 161 may be specified according to a scheme that includes high levels of abstraction; whereas, the data stream 121 may be specified according to a scheme with no or with minimal abstraction. As explained, the “ground truth” approach to a data stream can provide quite specific and granular information (e.g., number of servers, CPUs, memory, bandwidth, etc.). Where a buyer is allowed to specify its needs more abstractly, opportunities arise for more optimal management of resources if a mechanism exists to match abstracted needs to specific resources. As described herein, the agreement mechanism 160 can achieve such a goal, for example, through use of a domain-specific language. Such a mechanism can help bridge needs of buyers and needs of sellers, which, in turn, promotes market efficiency (e.g., by creating more liquid markets for cloud resources).

In the example of FIG. 7, the GUI 700 includes underlying control logic (e.g., software instructions) that allow for its display and functionality. The GUI 700 includes a graphics pane to display information as to cost of resources over time as well as information as, for example, needs for a buyer to run a web-based service or application. The GUI 700 also shows some options 720 that can be selected to, for example, filter information, generate or analyze terms of a service agreement (e.g., for SLAs) budget, view existing contracts (e.g., placements), ascertain current and/or future demand for the service or application, determine aspects of geography or distribution of service or application users and/or resources, and to make requests (e.g., bids). The GUI 700 of FIG. 7 is presented as an example as various aspects may be adapted or changed depending on specific needs of an operator of the agreement mechanism 160.

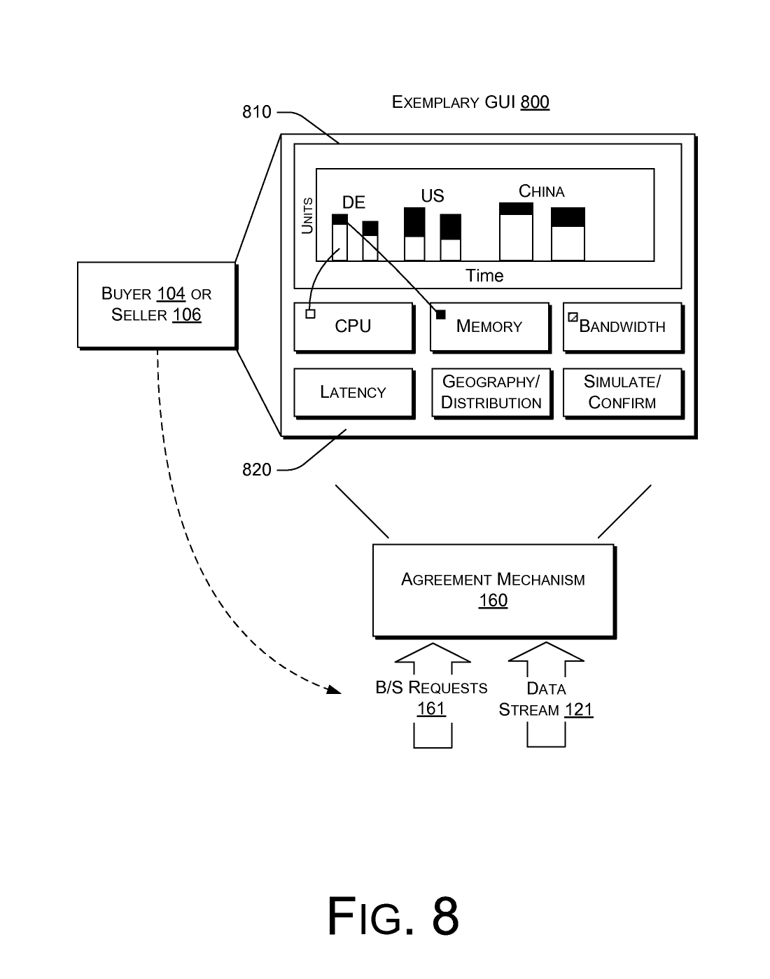

FIG. 8 shows another GUI 800, which may be available for a buyer 104 or seller 106 of resources. As shown in FIG. 8, the agreement mechanism 160 may include instructions for providing the GUI 800 (see also, e.g., the user interface 620 of FIG. 6). In this example, the agreement mechanism 160 can decide what information to expose to the buyer 104 or the seller 106. Such decisions may be made based wholly or in part on information from buyers and seller 161 and/or information from a data stream 121. In turn, the buyer 104 or the seller 106 can communicate information to the agreement mechanism 160 (e.g., to form a loop).

The GUI 800 includes a graphics pane to display information as to need or requirements for resources over time based on some options 820 that can be selected. For example, the buyer 104 may select “CPU” and then use a cursor to extend a CPU column representative of units desired or required at a certain point in time or period in time. The buyer 104 may then select memory and extend a memory unit column adjacent or on top of the CPU column or in any other suitable fashion. Next, the buyer 104 may select a geographical region or location, for example, Germany (DE) for location of the resources. After appropriate selections are made, for example, using an underlying DSL, the buyer 104 may select a simulate option or a confirm option. As already explained, such options allow the buyer 104 or the seller 106 to either have a simulation performed to cost or price the sought after resources or resources for sale, respectively. As explained in various examples, once the confirm option is selected, the agreement mechanism 160 can automatically bind the buyer 104 or the seller 106 to a service agreement.

As described herein, an exemplary service agreement module includes instructions (e.g., stored in one or more computer-readable media for execution by one or more processors), for receipt of information about sellable resources for running one or more web-based services; a solver for minimizing or maximizing a function subject to constraints associated with one or more web-based services; output of cost information for sellable resources for running one or more web-based services. In such an example, the cost information can include one or more types of cost information including fixed cost information, cost information based at least in part on minimizing or maximizing the function subject to the constraints, and auction cost information. Further, such an example can include instructions for receipt of a buy order for buying resources for running one or more web-based services where the buy order is based at least in part on output cost information. Additionally or alternatively, such an example can include instructions for receipt of an sell order for selling resources for running one or more web-based services where the sell order is based at least in part on output cost information (e.g., a sales price). An exemplary service agreement module may also include instructions for generation of a service agreement that is based at least in part on receipt of a buy or a sell order.

In the foregoing example, the service agreement module can include a convex solver for minimizing or maximizing a function subject to constraints specified by a buyer of resources for running one or more web-based services. As mentioned, constraints may be specified in a domain-specific language.

In a particular example, the output may output fixed cost information (e.g., buy for fixed cost), constraint-based cost information (e.g., cost information subject to constraints, which may vary over time) and auction cost information (e.g., bid/ask information). In this example, a buyer may decide whether to select a fixed cost or a constraint-based cost or to participate in an auction. These various options provide a buyer with some flexibility in risk management. For example, with respect to a long-term budget, the fixed cost may be a beneficial choice whereas for flexible, short-term needs, the auction may result in a low cost. Depending on the needs of a buyer, where such needs are expressed in more abstract terms, the constraint-based cost may represent a best fit of pooled resources to expressed needs and hence be of the best value.

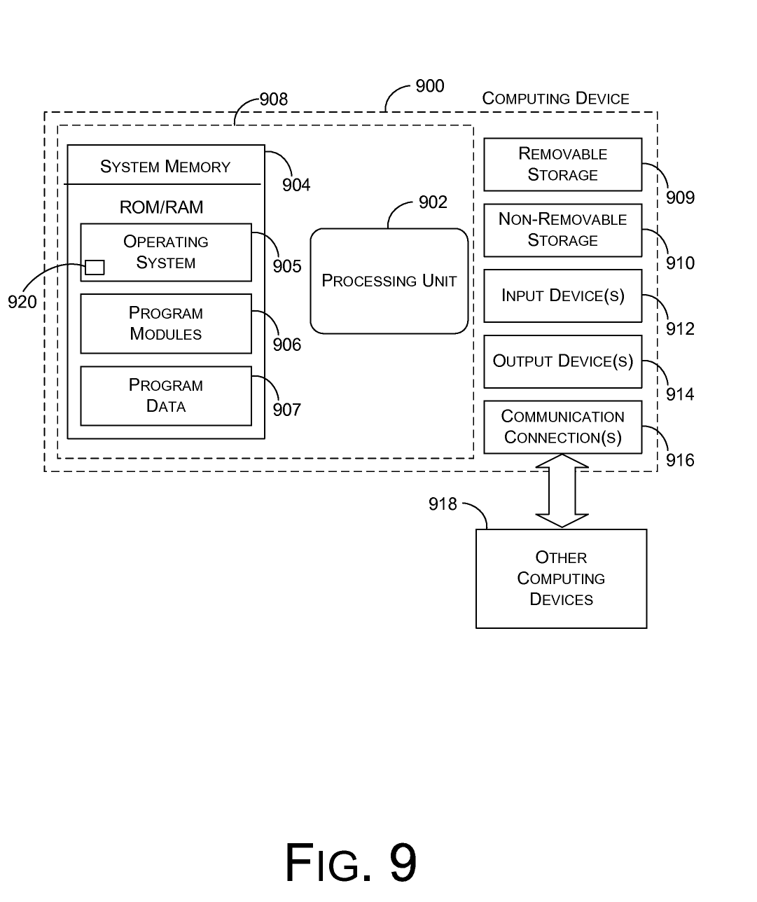

FIG. 9 illustrates an exemplary computing device 900 that may be used to implement various exemplary components and in forming an exemplary system. Such a device may be configured to perform tasks of the service 120, the agreement mechanism 160, the provisioning mechanism 170, etc. Such a device may be configured to display the GUI 700 of FIG. 7 or the GUI 800 of FIG. 8 and their associated functionality. Such a device may include suitable processing and memory capabilities to perform the matching or other tasks described herein, for example, where matching or other tasks may rely on convex programming.

In a very basic configuration, computing device 900 typically includes at least one processing unit 902 and system memory 904. Depending on the exact configuration and type of computing device, system memory 904 may be volatile (such as RAM), non-volatile (such as ROM, flash memory, etc.) or some combination of the two. System memory 904 typically includes an operating system 905, one or more program modules 906, and may include program data 907. The operating system 905 can include a component-based framework 920 that supports components (including properties and events), objects, inheritance, polymorphism, reflection, and provides an object-oriented component-based application programming interface (API), such as that of the .NET™ Framework marketed by Microsoft Corporation, Redmond, Wash. The device 900 is of a very basic configuration demarcated by a dashed line 908. Again, a terminal may have fewer components but will interact with a computing device that may have such a basic configuration.

Computing device 900 may have additional features or functionality. For example, computing device 900 may also include additional data storage devices (removable and/or non-removable) such as, for example, magnetic disks, optical disks, or tape. Such additional storage is illustrated in FIG. 9 by removable storage 909 and non-removable storage 910. Computer storage media may include volatile and nonvolatile, removable and non-removable media implemented in any method or technology for storage of information, such as computer readable instructions, data structures, program modules, or other data. System memory 904, removable storage 909 and non-removable storage 910 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 900. Any such computer storage media may be part of device 900. Computing device 900 may also have input device(s) 912 such as keyboard, mouse, pen, voice input device, touch input device, etc. Output device(s) 914 such as a display, speakers, printer, etc. may also be included. These devices are well known in the art and need not be discussed at length here.

Computing device 900 may also contain communication connections 916 that allow the device to communicate with other computing devices 918, such as over a network. Communication connections 916 are one example of communication media. Communication media may typically be embodied by computer readable instructions, data structures, program modules, or other data forms. By way of example, and not limitation, communication media includes wired media such as a wired network or direct-wired connection, and wireless media such as acoustic, RF, infrared and other wireless media.

While a general computing device is shown in FIG. 9, other equipment may be configured to perform one or more actions of the exemplary methods described herein. For example, a network device may be configured to perform one or more actions such as streaming data, acquiring data, issuing alerts, etc.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A matching module comprising instructions stored in one or more computer-readable media for execution by one or more processors, the matching module comprising instructions for:
receipt of information from a buyer of resources for running a web-based service;
receipt of information about sellable resources for running web-based services;
an algorithm for matching one or more buyers of resources to sellable resources by maximizing an objective, the matching based at least in part on received information from one or more buyers of resources and based at least in part on received information about sellable resources; and
output of cost information for sellable resources matched to one or more buyers, the cost information based at least in part on maximizing the objective.

2. The matching module of claim 1 wherein the information from a buyer comprises information specified in a domain-specific language.

3. The matching module of claim 2 further comprising instructions for translating the information specified in the domain-specific language to constraints that constrain the matching algorithm.

4. The matching module of claim 2 wherein the domain-specific language comprises language to specify constraints on availability of resources for running web-based services.

5. The matching module of claim 2 wherein the domain-specific language comprises language to specify a set or sets of resources as a sellable unit.

6. The matching module of claim 1 wherein the algorithm for matching comprises a convex solver.

7. The matching module of claim 1 wherein the cost information for the sellable resources comprises spot prices and future prices.

8. The matching module of claim 1 wherein the sellable resources comprise resources owned or managed by different organizations.

9. The matching module of claim 1 wherein the information from a buyer of resources differs from the information about sellable resources.

10. The matching module of claim 9 wherein the information from a buyer of resources comprises abstracted information, abstracted at a higher level than the information about sellable resources.

11. The matching module of claim 1 further comprising instructions, responsive to receipt of an order from a buyer of resources, to generate a service level agreement for the buyer of resources.

12. An interpretation module comprising instructions stored in one or more computer-readable media for execution by one or more processors, the interpretation module comprising instructions for:
receipt of information in a domain-specific language, the domain-specific language for specifying properties of resources for hosting web-based services; and
interpreting the information in the domain-specific language to generate one or more constraints and an objective function for minimization or maximization subject to the one or more constraints by a solver to provide for pricing resources for hosting web-based services.

13. The interpretation module of claim 12 wherein the domain-specific language comprises language for expression of one or more constraints selected from a group consisting of positive cost constraints, negative cost constraints, time constraints, energy constraints, latency constraints, resource constraints, geography constraints, availability constraints, demand constraints and penalty constraints.

14. The interpretation module of claim 12 wherein the pricing of resources comprises generating one or more prices selected from a group consisting of spot prices, future prices, option prices and penalty prices.

15. The interpretation module of claim 12 wherein the domain-specific language comprises language to specify a set of resources and aggregate availability constraints over a set or sets of resources.

16. The interpretation module of claim 12 wherein the generated constraints comprise constraints amenable to use in a matching algorithm that comprises a convex solver.

17. The interpretation module of claim 16 wherein the generated constraints are convex.

18. A service agreement module comprising instructions stored in one or more computer-readable media for execution by one or more processors, the service agreement module comprising instructions for:
receipt of information about sellable resources for running one or more web-based services;
a convex solver for minimizing or maximizing a function subject to constraints associated with one or more web-based services;
output of cost information for sellable resources for running one or more web-based services wherein the cost information comprises one or more types of cost information selected from a group consisting of
fixed cost information,
cost information based at least in part on minimizing or maximizing the function subject to the constraints, and
auction cost information;
receipt of an order for resources for running one or more web-based services, the order based at least in part on output cost information; and
generation of a service agreement, the service agreement based at least in part on receipt of an order.

19. The service agreement module of claim 18 wherein the convex solver for minimizing or maximizing a function subject to constraints comprises constraints specified by a buyer of resources for running one or more web-based services.

20. The service agreement module of claim 19 wherein the constraints comprise constraints derived from information received from the buyer in a domain-specific language.
